(19) United States
(12) Patent Application Publication
(10) Pub. No.: US 2024/0186048 A1
(43) Pub. Date: Jun. 6, 2024

(54) PERMANENT MAGNET MANUFACTURING METHOD AND MAGNETIZER

(71) Applicant: MINEBEA MITSUMI Inc., Nagano (JP)

(72) Inventors: Haruhiro KOMURA, Kitasaku-gun (JP); Yu OKAWARA, Kitasaku-gun (JP); Kaoru NISHIGUCHI, Kitasaku-gun (JP); Satoshi AIDA, Kitasaku-gun (JP)

(21) Appl. No.: 18/554,005

(22) PCT Filed: Mar. 14, 2022
(86) PCT No.: PCT/JP2022/011299

§ 371 Date: Oct. 5, 2023

(30) Foreign Application Priority Data
Apr. 19, 2021 (JP) 2021-070163

(51) Int. Cl. H01F 13/00; H01F 41/02

(52) U.S. Cl. CPC H01F 13/003; H01F 41/0253

(57) ABSTRACT

A permanent magnet manufacturing method according to an embodiment includes a heating step of disposing a field magnet part near a to-be-magnetized object, the field magnet part having a plurality of permanent magnets for magnetization arranged at predetermined intervals to apply a magnetization magnetic field to the to-be-magnetized object and heating the to-be-magnetized object to a temperature equal to or higher than the Curie point of the to-be-magnetized object, and a magnetization step of cooling the to-be-magnetized object having reached the temperature equal to or higher than the Curie point to a temperature lower than the Curie point and continuously applying a magnetization magnetic field to the to-be-magnetized object by the field magnet unit, and the permanent magnets for magnetization are isotropic SmCo sintered magnets in a predetermined shape.

### CROSS REFERENCE TO RELATED APPLICATIONS

This application is a national stage entry of International Application No. PCT/JP2022/011299, filed on Mar. 14, 2022, which claims priority to Japanese Patent Application 2021-070163, filed on Apr. 19, 2021, which is incorporated herein by reference.

### TECHNICAL FIELD

The disclosure relates to a permanent magnet manufacturing method and a magnetizer.

### BACKGROUND

In the related art, a technique for multipolar magnetization with a narrow magnetization pitch is known (for example, see JP 2006-295122 A and “Powder and Powder Metallurgy”, Vol. 57 (2010), No. 1, p. 19-p. 26). According to this magnetization technique, a heating unit heats a to-be-magnetized object to rapidly heat the object to a temperature higher than the Curie point of a magnetic powder constituting the to-be-magnetized object, and then the temperature is lowered to a temperature lower than the Curie point while permanent magnets of a field magnet part continuously generate a magnetic field, thereby performing multipolar magnetization with a narrow magnetization pitch.

In the magnetizer according to the above-described magnetization technique, the heating unit and the magnetizing unit are arranged in the axial direction as separate structures, SmCo sintered magnets serving as a field magnet source equal in number to a desired number of poles are arranged to form a field magnet space, and the to-be-magnetized object is rapidly heated to a temperature higher than the Curie point and then cooled at the field magnet space. During this time, the SmCo sintered magnets continuously apply a magnetization magnetic field to the to-be-magnetized object, thereby providing strong magnetization characteristics.

SmCo sintered magnets are used as permanent magnets serving as a field magnet source in the above-described magnetization technique. Here, Non Patent Document 1 describes SmCo sintered magnets serving as a field magnet source, stating “The generated magnetic field of the SmCo sintered magnets was calculated to be 160 kA/m or more even at 320° C. at the outer circumferential portion of the magnets where magnetization takes place. Thus, it has been found that the magnets have a sufficient magnetization magnetic field for magnetizing Nd—Fe—B magnets”. From this description, it can be seen that the SmCo sintered magnets used for a field magnet source are anisotropic sintered magnets.

### SUMMARY

An anisotropic sintered magnet constituting the field magnet part of the magnetizer according to the above-described magnetization technique is generally manufactured by applying an orientation magnetic field to form the magnet under a predetermined pressure and then sintering the magnet at a predetermined temperature in order to align the axis of easy magnetization of crystal grains in a predetermined direction.

When a sintered magnet is manufactured by applying an orienting magnetic field, applying a predetermined pressure, and then performing sintering at a predetermined temperature, the orientation direction may be deviated (disturbed) from a predetermined direction, and as a result, the magnetic characteristics of some parts of the block of the sintered magnet may deteriorate due to the deviation of the orientation.

Usually, the block of a sintered magnet manufactured by sintering is cut into a desired shape in cutting processing and then magnetized. Although the magnetization is performed in a direction corresponding to the direction of the orienting magnetic field, the magnetization magnetic field follows the orientation direction. Thus, the sintered magnet cut out from the part with deviated orientation becomes a magnet having weaker magnetic characteristics than the sintered magnet cut out from other parts, and the magnetic characteristics vary depending on the part cut out from the block.

When a magnetic sensor, for example, a permanent magnet for a magnetic encoder, is magnetized using a magnetizer according to the above-described magnetization technique, a magnetic pattern (alternately formed N-poles and S-poles) formed in a circumferential direction of a magnet surface has partially different magnetization characteristics, resulting in variations in surface magnetic flux density. Although the magnetic encoder recognizes information about a position by detecting a magnetic pattern formed at a magnet surface, if there is a variation in a surface magnetic flux density of the magnetic pattern, there is a possibility of the signal accuracy of the encoder becoming lower.

In view of the problems described above, the disclosure aims to provide a permanent magnet manufacturing method and a magnetizer that can improve the uniformity of magnetization characteristics of a magnetic pattern with multipolar magnetization on a surface of a to-be-magnetized object.

In order to solve the above-described problem and achieve the goal, a permanent magnet manufacturing method according to an aspect of the disclosure includes disposing a field magnet part near a to-be-magnetized object, the field magnet part having a plurality of permanent magnets for magnetization arranged at predetermined intervals to apply a magnetization magnetic field to the to-be-magnetized object, and heating the to-be-magnetized object to a temperature equal to or higher than the Curie point of the to-be-magnetized object, and cooling the to-be-magnetized object having reached the temperature equal to or higher than the Curie point to a temperature lower than the Curie point and continuously applying a magnetization magnetic field to the to-be-magnetized object by the field magnet part; the permanent magnets for magnetization being isotropic SmCo sintered magnets in a predetermined shape.

According to one aspect of the disclosure, it is possible to improve the uniformity of the magnetization characteristics of the magnetic pattern with multipolar magnetization of a surface of a to-be-magnetized object.

### BRIEF DESCRIPTION OF DRAWINGS

FIG. 1 is a view illustrating a schematic configuration example of a magnetizer used in a permanent magnet manufacturing method according to an embodiment.

FIG. 2 is a perspective view illustrating a field magnet part of the magnetizer illustrated in FIG. 1.

FIG. 3 is a cross-sectional view illustrating a magnetized object.

FIG. 4 is a view for explaining an operation of the magnetizer illustrated in FIG. 1.

FIG. 5 is a view for explaining an operation of the magnetizer illustrated in FIG. 1.

FIG. 6 is a view for explaining an operation of the magnetizer illustrated in FIG. 1.

FIG. 7 is a view for explaining an evaluation method in an example.

FIG. 8 is a view showing measurement results in the example.

FIGS. 9A to 9C are views for explaining a generated magnetic field of an isotropic SmCo sintered magnet illustrated in FIG. 8.

FIGS. 10A to 10C are views for explaining a generated magnetic field of an anisotropic SmCo sintered magnet illustrated in FIG. 8.

FIG. 11 is a graph showing the uniformity of the generated magnetic fields of evaluated samples in terms of standard deviation.

FIG. 12 is a view illustrating a schematic configuration example of a magnetizer according to a first modification example.

FIG. 13 is a view illustrating a schematic configuration example of the magnetizer according to the first modification example.

FIG. 14 is a perspective view illustrating a field magnet part of the magnetizer illustrated in FIG. 13.

### DESCRIPTION OF EMBODIMENTS

A permanent magnetic manufacturing method and a magnetizer according to an embodiment will be described with reference to the accompanying drawings. Further, the disclosure is not limited to the embodiment. Furthermore, the dimensional relationships between elements, proportions of the elements, and the like in the drawings may differ from reality. The drawings may include parts having mutually different dimensional relationships and proportions. Furthermore, the contents described in one embodiment or modification examples are applied in principle to other embodiments or modification examples.

### EMBODIMENTS

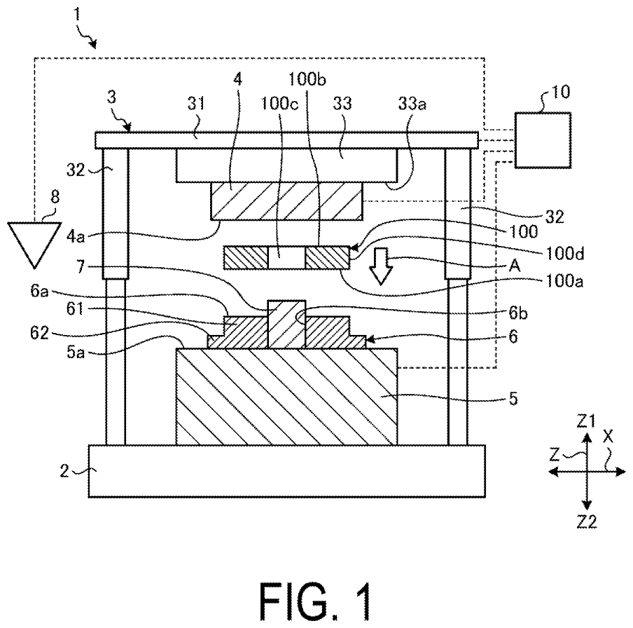

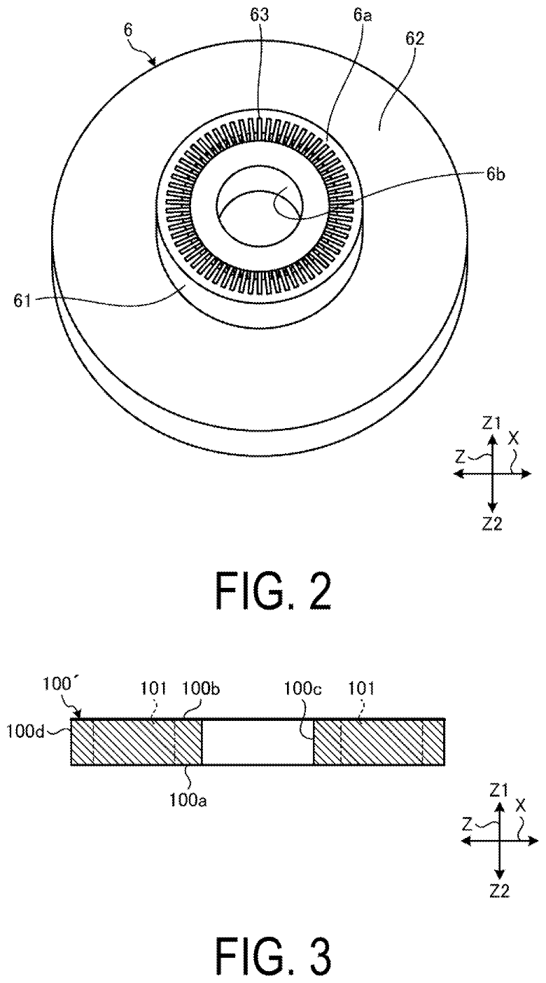

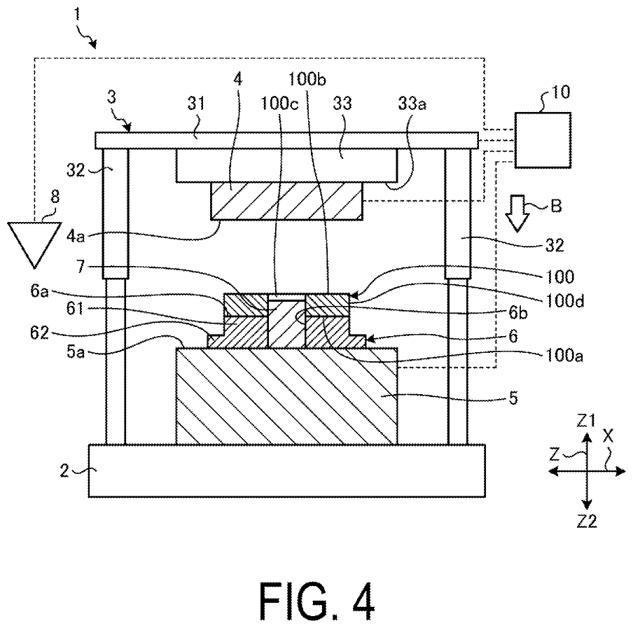

First, an example of a magnetizer used in a permanent magnet manufacturing method according to an embodiment will be described. FIG. 1 is a view illustrating a schematic configuration example of a magnetizer used in a permanent magnet manufacturing method according to an embodiment. FIG. 2 is a perspective view illustrating a field magnet part of the magnetizer illustrated in FIG. 1. FIG. 3 is a cross-sectional view illustrating a magnetized object. FIGS. 4 to 6 are views for explaining an operation of the magnetizer illustrated in FIG. 1. Further, FIG. 3 is a cross-sectional view of the to-be-magnetized object at a plane including the axial direction. Here, the X direction in each figure is the radial direction of the to-be-magnetized object in the present embodiment. The Z direction is the axial direction of the to-be-magnetized object and is the vertical direction, the Z1 direction is the upward direction, and the Z2 direction is the downward direction.

A magnetizer 1 used in the permanent magnet manufacturing method according to the embodiment magnetizes a to-be-magnetized object 100 to manufacture a magnetized object 100′ as illustrated in FIGS. 1 to 3. The magnetizer 1 includes a pedestal 2, a movement unit 3, a heating unit 4, a preheating unit 5, a field magnet part 6, a positioning pin 7, a cooling unit 8, and a control unit 10.

The pedestal 2 is a base portion of the magnetizer 1, and at least the movement unit 3, the heating unit 4, the preheating unit 5, the field magnet part 6, the positioning pin 7, the cooling unit 8, and the control unit 10 are mounted at the pedestal 2.

The movement unit 3 moves the to-be-magnetized object 100 and the heating unit 4 with respect to each other between a non-heating position and a heating position in the axial direction. The movement unit 3 illustrated in FIG. 1 includes a ceiling plate 31, actuators 32, and a heating unit mounting table 33. The ceiling plate 31 is disposed to be separated from the pedestal 2 in the axial direction, and the actuators 32 and the heating unit mounting table 33 are fixed to the ceiling plate 31. The actuators 32 move the ceiling plate 31 with respect to the pedestal 2 in the axial direction. The actuators 32 are, for example, linear motion mechanisms such as hydraulic cylinders that are supplied with electric power from external power, which is not illustrated, and driven and controlled by the control unit 10. A plurality of actuators 32, for example, two or four actuators 32, are disposed between the pedestal 2 and the ceiling plate 31. The heating unit 4 is fixed to the heating unit mounting table 33, which is fixed to the lower side surface of the ceiling plate 31.

The heating unit 4 heats the to-be-magnetized object 100 for magnetization. The heating unit 4 is made of a non-magnetic metal material, for example, non-magnetic stainless steel, or the like, and heats the to-be-magnetized object 100 to a temperature equal to or higher than the Curie point of the magnetic powder constituting the to-be-magnetized object 100. The heating unit 4 of the present embodiment is formed in a disc shape, and between both surfaces in the vertical direction, the upper side surface is fixed to the heating unit mounting table 33 of the movement unit 3, and the lower side surface is a heating surface 4a. The heating surface 4a is formed to have an outer diameter larger than the outer diameter of the to-be-magnetized object 100, and faces a placement surface 6a of the field magnet part 6, which will be described later, in the axial direction. That is, the heating surface 4a faces the to-be-magnetized object 100 placed at the placement surface 6a in the axial direction. Furthermore, the heating surface 4a comes into contact with the to-be-magnetized object 100 at the heating position. The heating unit 4 includes one or more heaters and is supplied with electric power from external power, which is not illustrated, and its temperature is controlled by the control unit 10.

The preheating unit 5 preliminarily heats the to-be-magnetized object 100 for magnetization. The preheating unit 5 is made of a non-magnetic metal material and heats the to-be-magnetized object 100 to a temperature lower than the Curie point (a temperature higher than room temperature) of the magnetic powder constituting the to-be-magnetized object 100 before the to-be-magnetized object 100 reaches the heating position. The preheating unit 5 of the present embodiment is formed in a columnar shape, and the field magnet part 6 and the positioning pin 7 are fixed to the preheating unit 5. Here, the preheating unit 5 heats the to-be-magnetized object 100 placed at the field magnet part 6 through the field magnet part 6 and the positioning pin 7. Between both surfaces of the preheating unit 5 in the vertical direction, the lower side surface is fixed to the pedestal 2, and the upper side surface is a placement/heating surface 5a. The placement/heating surface 5a is formed to be larger than the outer diameter of the field magnet part 6, and comes into contact with the field magnet part 6 and the positioning pin 7. The preheating unit 5 is supplied with electric power from external power, which is not illustrated and has one or more heaters, and its temperature is controlled by the control unit 10.

The field magnet part 6 generates a magnetic field for the to-be-magnetized object 100. The field magnet part 6 of the present embodiment magnetizes the to-be-magnetized object 100 in the axial direction, and includes a main body part 61, a flange part 62, and permanent magnets 63 which are permanent magnets for magnetization. The main body part 61 is made of a non-magnetic metal material in a cylindrical shape, the lower side surface of both surfaces in the vertical direction is fixed to the placement/heating surface 5a of the preheating unit 5, and the upper side surface is the placement surface 6a for placing the to-be-magnetized object 100. An insertion hole 6b into which the positioning pin 7 is inserted is formed at the main body part 61. The flange part 62 is formed to protrude radially outward from the lower end part of the main body part 61. The flange part 62 fixes the field magnet part 6 to the preheating unit 5 as a fixing tool, for example, a fastening screw, is inserted into a through hole, which is not illustrated, and the fixing tool is fixed to the preheating unit 5 with the field magnet part 6 placed at the placement/heating surface 5a of the preheating unit 5. The permanent magnets 63 are embedded at an upper end part of the main body part 61, generate a magnetic field for the to-be-magnetized object 100, and are, for example, rectangular SmCo sintered magnets. When viewed in the vertical direction, a plurality of permanent magnets 63 are arranged at equal intervals in the circumferential direction of a concentric circle around the center of the main body part 61. In the field magnet part 6, a plurality of recessed parts are formed radially in the circumferential direction at predetermined intervals, and the plurality of permanent magnets 63 are disposed at each of the plurality of recessed parts. Each permanent magnet 63 has two magnetic poles (an S pole and an N pole) at the upper direction side and the lower direction side, and is embedded in the main body part 61 such that the different magnetic poles alternate in the circumferential direction. Here, the magnetic pole (for example, the S pole) at the upper side of a permanent magnet 63 is different from the magnetic pole (for example, the N pole) on the upper side of the permanent magnet 63 adjacent in the circumferential direction, and the magnetic pole (for example, the N pole) on the lower side of the permanent magnet 63 is different from the magnetic pole (for example, the S pole) at the lower side of the permanent magnet 63 adjacent in the circumferential direction. Further, although the permanent magnets 63 are embedded in the main body part 61 to be exposed at the placement surface 6a in FIG. 2, the permanent magnets may be embedded inside the main body part 61 without being exposed at the placement surface 6a.

In addition, a shape of the permanent magnets 63 is not limited to a rectangular shape, and may be any shape as long as the permanent magnets 63 can be embedded in the main body part 61. For example, the permanent magnets 63 may have a fan shape in a top view. In addition, although FIG. 2 illustrates the field magnet part 6 with the permanent magnets 63 being arranged in a concentric circle around the center of the main body part 61, the present embodiment is not limited to the aforementioned. For example, in the present embodiment, a field magnet part 6 may be used with the permanent magnets 63 being arranged in two concentric circles having different diameters.

The positioning pin 7 determines the position of the to-be-magnetized object 100 with respect to the field magnet part 6 in the radial direction, and is inserted into a through hole 100c of the to-be-magnetized object 100, which will be described later. The positioning pin 7 is fixed to the preheating unit 5 by being inserted into the insertion hole 6b of the field magnet part 6 while the field magnet part 6 is fixed to the preheating unit 5.

The cooling unit 8 cools the to-be-magnetized object 100 heated by the heating unit 4. The cooling unit 8 of the present embodiment is fixed to the pedestal 2 by a fixing member, which is not illustrated, and outputs air toward the to-be-magnetized object 100 placed at the field magnet part 6. The cooling unit 8 is, for example, an air cooling fan, a compressor that supplies compressed air, or the like, and cools the heated to-be-magnetized object 100 not by natural air cooling but by forced air cooling that is high in cooling efficiency. The cooling unit 8 is supplied with electric power from external power, which is not illustrated, and is controlled for air blowing by the control unit 10.

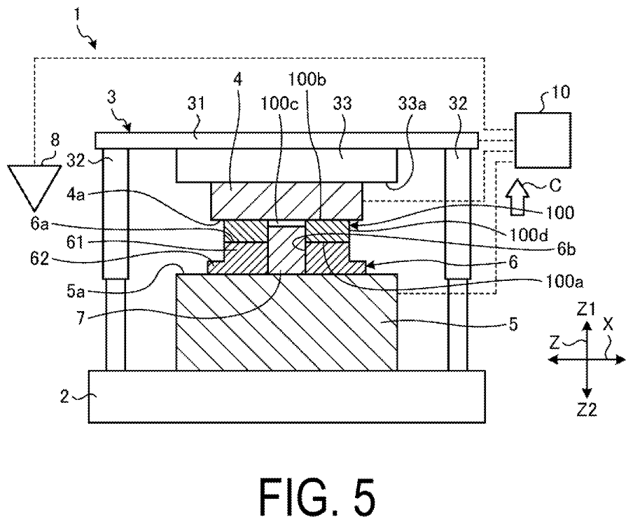

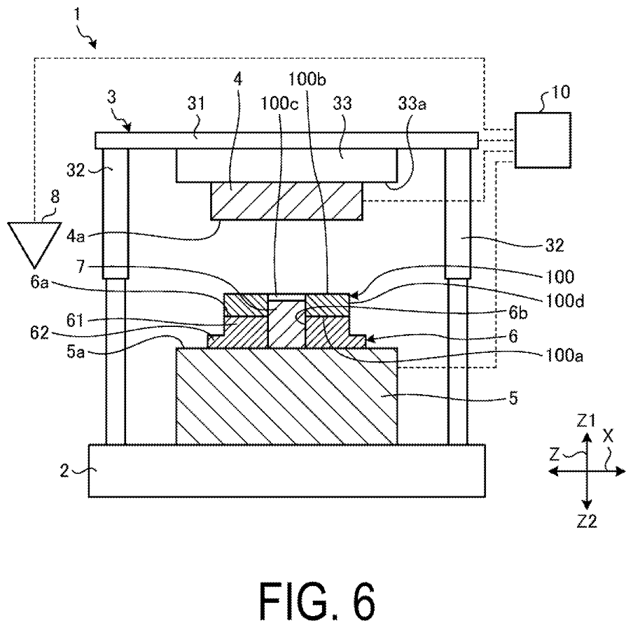

The control unit 10 controls the magnetizer 1 in order to magnetize the to-be-magnetized object 100. The control unit 10 controls the movement unit 3, the heating unit 4, the preheating unit 5, and the cooling unit 8. The control unit 10 controls driving of the movement unit 3 to move the heating unit 4 with respect to the to-be-magnetized object 100 placed at the field magnet part 6 to the non-heating position and to the heating position. Here, the non-heating position is a position (non-contact) at which the heating surface 4a is separated from the to-be-magnetized object 100 in the axial direction and the to-be-magnetized object 100 is not heated by the heating unit 4 (see FIG. 4). On the other hand, the heating position is a position at which the heating surface 4a is close to the to-be-magnetized object 100 in the axial direction (in the present embodiment, the heating surface 4a is in contact with the to-be-magnetized object 100) and the to-be-magnetized object 100 is heated by the heating unit 4 (see FIG. 5). The control unit 10 controls the temperature of the heating unit 4 to heat the heating unit 4 to reach a heating temperature equal to or higher than the Curie point of the magnetic powder constituting the to-be-magnetized object 100. In the present embodiment, before the heating unit 4 reaches the heating position, the control unit 10 heats the heating unit so that the temperature of the heating unit is higher than the Curie point by 30° C. or more and is lower than or equal to 350° C. The heating temperature is a temperature at which deterioration of magnetic characteristics of the magnetic powder constituting the to-be-magnetized object 100 and deterioration of a thermosetting resin described later can be curbed. Further, the heating temperature is a temperature lower than the Curie point of the permanent magnet for magnetization. Here, the control unit 10 controls a pressing force applied to the to-be-magnetized object 100 by the heating unit 4 when the heating surface 4a comes into contact with the to-be-magnetized object 100. When the heating surface 4a comes into contact with the to-be-magnetized object 100, the control unit 10 controls driving of the movement unit 3 to obtain a pressing force that can prevent damage to the to-be-magnetized object 100. As a result, damage to the to-be-magnetized object 100 can be prevented, and the to-be-magnetized object 100 and the heating unit 4 can be in a uniform contact state. The control unit 10 controls the temperature of the preheating unit 5 such that the preheating unit 5 is heated to a preheating temperature lower than the Curie point of the magnetic powder constituting the to-be-magnetized object 100 before the preheating unit reaches the heating position. In the present embodiment, before the preheating unit 5 reaches the heating position, the control unit 10 heats the preheating unit so that the temperature of the preheating unit is lower than the Curie point by 30° C. or more and is higher than or equal to 150° C. That is, a preferable range of a preliminary temperature T is T<T_{c}, and a more preferable range of the preliminary temperature T is T≤T_{c}−30. In addition, more specifically, the range is 150° C.≤T<T_{c}, and even more specifically, the range is 150° C.≤T≤T_{c}−30. By controlling temperature of the cooling unit 8, the control unit 10 causes the heated to-be-magnetized object 100 to be cooled after the position is changed from the heating position to the non-heating position (see FIG. 6).

Here, the to-be-magnetized object 100 and the magnetized object 100′ are formed in a ring shape and have a lower side surface 100a and an upper side surface 100b which are both surfaces in the axial direction, the through hole 100c, and an outer circumferential surface 100d as illustrated in FIGS. 1 and 3. The to-be-magnetized object 100 is a rare earth iron-based magnet before magnetization, and in the present embodiment, for example, is formed by mixing magnetic powder containing neodymium (Nd—Fe—B), which is a magnetically isotropic rare earth iron-based magnet, and a thermosetting resin, for example, an epoxy resin, at a predetermined ratio. The to-be-magnetized object 100 is not a to-be-magnetized object that is small but a so-called to-be-magnetized object that is large, and formed in a ring shape having an outer diameter of 10 mm or more, preferably 15 mm or more and 50 mm or less as an example.

The to-be-magnetized object 100 is preferably an anisotropic rare earth iron-based magnet having an average grain size of 10 nm or more and 10000 nm or less, and more preferably an anisotropic rare earth iron-based magnet having an average grain size of 10 nm or more and 6600 nm or less. When such an anisotropic rare earth iron-based magnet is used, it can be strongly magnetized by the above-described magnetizer 1.

Next, a method of magnetizing the to-be-magnetized object 100 by the magnetizer 1 according to the present embodiment will be described. Further, the magnetizer 1 is at the non-heating position. In addition, the to-be-magnetized object 100 is formed in a ring shape in advance according to the number of objects to be manufactured. First, the control unit 10 starts heating of the heating unit 4 and the preheating unit 5 as illustrated in FIG. 1. Here, the control unit 10 heats the heating unit 4 to the heating temperature and heats the preheating unit 5 to the preheating temperature. Next, an operator moves the to-be-magnetized object 100 downward (indicated by the arrow A in the drawing) having the through-hole 100c of the to-be-magnetized object 100 and the positioning pin 7 face each other in the axial direction. As a result, the to-be-magnetized object 100 is placed at the placement surface 6a of the field magnet part 6 as illustrated in FIG. 4. At this time, the operator positions the to-be-magnetized object 100 with respect to the magnetizer 1 by inserting the upper end part of the positioning pin protruding from the placement surface 6a of the field magnet part 6 into the through hole 100c of the to-be-magnetized object 100. Further, the upper side surface 100b of the to-be-magnetized object 100 faces the heating surface 4a of the heating unit 4 in the axial direction.

Next, after a first predetermined time T1 elapses from the placement of the to-be-magnetized object 100 at the placement surface 6a, the control unit 10 causes the movement unit 3 to move the heating unit 4 from the non-heating position to the heating position (indicated by the arrow B in the drawing) with respect to the to-be-magnetized object 100. Here, the first predetermined time T1 is a sufficient time for the to-be-magnetized object 100 placed at the placement surface 6a to receive heat from the preheating unit 5 via the field magnet part 6 and thus the to-be-magnetized object 100 can reach a temperature higher than room temperature and lower than the Curie point while the heating unit 4 maintains the heating temperature. That is, after the heating unit 4 reaches the heating temperature and the to-be-magnetized object 100 reaches the preheating temperature at the non-heating position, the control unit 10 causes the heating unit 4 to be moved to the heating position with respect to the to-be-magnetized object 100 and starts heating the preheated to-be-magnetized object 100 with the heating surface 4a in contact with the to-be-magnetized object 100. Further, when the heating unit 4 is moved from the non-heating position to the heating position with respect to the to-be-magnetized object 100 by the movement unit 3, the control unit 10 ends the heating by the preheating unit 5, that is, turns off the temperature control. Next, the control unit 10 causes the to-be-magnetized object 100 to be heated to the Curie point or higher while the heating surface 4a is in contact with the to-be-magnetized object 100 as illustrated in FIG. 5. Next, after a second predetermined time T2 elapses from the start of heating of the to-be-magnetized object 100 at the heating position, the control unit 10 causes the movement unit 3 to move the heating unit 4 from the heating position to the non-heating position with respect to the to-be-magnetized object 100 (indicated by the arrow C in the same drawing). Here, the second predetermined time T2 is a sufficient time for the to-be-magnetized object 100 to reach the Curie point or higher.

Next, the control unit 10 causes the cooling unit 8 to cool the to-be-magnetized object 100 at the non-heating position as illustrated in FIG. 6. Next, after a third predetermined time T3 elapses from the start of cooling by the cooling unit 8 at the non-heating position, the control unit 10 ends the cooling by the cooling unit 8. Here, the third predetermined time T3 is a sufficient time for the to-be-magnetized object 100 to go from the Curie point or higher to a temperature lower than the Curie point; preferably, a temperature lower than the Curie point by 50° C.

Next, the operator takes out the magnetized object 100′. When the magnetizer 1 newly magnetizes the to-be-magnetized object 100, the control unit 10 starts heating the preheating unit 5 because the heating unit 4 has already been heated.

As described above, the magnetizer 1 according to the present embodiment magnetizes the to-be-magnetized object 100 by increasing the temperature of the to-be-magnetized object 100 from a temperature lower than the Curie point to a temperature equal to or higher than the Curie point and decreasing the temperature of the to-be-magnetized object 100 from the temperature equal to or higher than the Curie point to a temperature lower than the Curie point while the magnetization magnetic field is applied by the field magnet part 6. As a result, the magnetizer 1 manufactures the magnetized object 100′ from the to-be-magnetized object 100 as illustrated in FIG. 3. The region in the magnetized object 100′ corresponding to the permanent magnets 63 of the field magnet part 6 is magnetized. The magnetized object 100′ of the present embodiment is a permanent magnet having a magnetization region 101 corresponding to the respective permanent magnets 63, and is a permanent magnet having one row of at least the lower side surface 100a magnetized to be multipolar in a ring shape. Here, in order to heat the to-be-magnetized object 100 in the axial direction by the heating unit 4, that is, in order to set the heating surface 4a and the upper side surface 100b of the to-be-magnetized object 100 to face each other and to be heated, the upper side surface 100b which is one of both surfaces of the magnetized object 100′ in the axial direction has a thicker oxide film in the radial direction, compared with the outer circumferential surface 100d. As a result, it has been confirmed that, in the magnetized object 100′, the amount of Nd is greater and more Nd is segregated in the upper side surface 100d than in the outer circumferential surface 100b.

In the magnetizer 1 according to the present embodiment, the heating surface 4a of the heating unit 4 is closer to the to-be-magnetized object 100 in the axial direction at the heating position than at the non-heating position, and thus the to-be-magnetized object 100 is heated by the heating unit 4 in the axial direction. Therefore, when the heating unit 4 heats the to-be-magnetized object 100 in the axial direction, i.e., setting the heating surface 4a to face the upper side surface 100b of the to-be-magnetized object 100 to be heated, uneven heating of the to-be-magnetized object 100 can be curbed, and irregular heating of the to-be-magnetized object 100 can be curbed, as compared with the case of the heating unit 4 heating the to-be-magnetized object 100 in the radial direction, i.e., setting the heating surface 4a to face the outer circumferential surface 100d of the to-be-magnetized object 100 to be heated. In particular, the to-be-magnetized object 100 that is large has a larger heat capacity than the to-be-magnetized object 100 that is small. Since the to-be-magnetized object 100 that is small is easily heated and easily cooled, the temperature distribution in the to-be-magnetized object 100 is unlikely to be biased; however, when the to-be-magnetized object is large, for example, has a large diameter, the to-be-magnetized object 100 is likely to be irregularly heated. In the case of a large to-be-magnetized object 100, it is possible to further increase the heating temperature or to lengthen the second predetermined time T2 in order to curb the occurrence of irregular heating; however, there is concern that deterioration of the magnetic characteristics of the magnetic powder constituting the to-be-magnetized object 100 and deterioration of a thermosetting resin may occur. However, since the magnetizer 1 according to the present embodiment heats the to-be-magnetized object 100 in the axial direction, that is, setting the heating surface 4a to face the upper side surface 100b of the to-be-magnetized object 100 to be heated even if the to-be-magnetized object 100 is large, irregular heating of the to-be-magnetized object 100 can be curbed even if the heating temperature is not high and the second predetermined time T2 is not long. As a result, it is possible to curb the temperature of the to-be-magnetized object 100 from being non-uniform while a magnetization magnetic field is applied to the to-be-magnetized object 100 by the field magnet part 6, and thus uniformity of magnetization characteristics of the to-be-magnetized object 100 can be achieved.

As described above, the permanent magnet manufacturing method according to the present embodiment includes a heating step of heating the to-be-magnetized object 100 to a temperature equal to or higher than the Curie point of the to-be-magnetized object 100 by disposing the field magnet part 6 near the to-be-magnetized object 100, the field magnet part 6 having a plurality of permanent magnets 63 arranged at predetermined intervals (e.g., equal intervals), the permanent magnets 63 being permanent magnets for magnetization for applying a magnetization magnetic field to the to-be-magnetized object 100, and a magnetizing step of continuously applying a magnetization magnetic field to the to-be-magnetized object by the field magnet part 6 while cooling the to-be-magnetized object 100 having reached a temperature equal to or higher than the Curie point to a temperature lower than the Curie point. In addition, in the permanent magnet manufacturing method according to the present embodiment, isotropic SmCo sintered magnets having a predetermined shape (for example, a strip shape) are used as the permanent magnets 63 which are permanent magnets for magnetization. Thus, in the present embodiment, the uniformity of the magnetization characteristics of the magnetic pattern of multipolar magnetization at the surface of the magnetized object 100′ can be improved. This point will be described below.

Since the SmCo sintered magnets used as permanent magnets for magnetization in the present embodiment are isotropic, they are molded under a predetermined pressure without applying an orientating magnetic field at the time of molding, and then sintered at a predetermined temperature to be manufactured. A block sintered at a predetermined temperature is cut into a predetermined shape by machining to obtain a strip-shaped magnet. Then, the cut-out strip-shaped magnet is magnetized in a predetermined direction, and then disposed in, for example, the field magnet part 6 of the magnetizer 1.

On the other hand, since a SmCo sintered magnet used as a permanent magnet for magnetization is generally an anisotropic magnet, the magnet is molded under a predetermined pressure while applying an orientating magnetic field in a predetermined direction at the time of molding, and then sintered at a predetermined temperature to be manufactured. In the step, the orientation direction may deviate from a predetermined direction, and as a result, the deviation of the orientation may cause variations in magnetic characteristics depending on a portion of the block of the sintered magnet. In this regard, since the isotropic SmCo sintered magnet is used in the present embodiment, the deviation of the orientation direction does not occur, and the variation of the magnetic characteristics is smaller than that in the case of an anisotropic magnet, and thus desired magnetization can be performed.

Further, since the isotropic SmCo sintered magnet has lower magnetic characteristics (lower value of surface magnetic flux density) than an anisotropic SmCo sintered magnet, the magnetization characteristics given to the to-be-magnetized object 100 become lower. For example, the generated magnetic field of an anisotropic SmCo sintered magnet as a field magnet source is calculated to be 160 kA/m or more at 320° C. at a position 0.3 mm away from the outer circumferential side part of the magnet to be magnetized. On the other hand, the generated magnetic field of an isotropic SmCo sintered magnet has a value equal to or higher than 40 kA/m and less than 160 kA/m, which is lower than the generated magnetic field value of an anisotropic SmCo sintered magnet. However, in a permanent magnet for a magnetic encoder, the magnitude of the magnetization magnetic field of an isotropic SmCo sintered magnet does not cause any problem in practical use. Rather, for accurate sensing, it is important to minimize the distribution variation of the generated magnetic field of the permanent magnet used for magnetizing the permanent magnet for the magnetic encoder. In this regard, in the isotropic SmCo sintered magnet, there is no variation in magnetic characteristics due to deviation of the orientation, and thus, when the magnetized object 100′ magnetized by the isotropic SmCo sintered magnet is used as a member for a magnetic sensor, uniformity of magnetization characteristics is improved, and accuracy of sensing can be improved.

### EXAMPLES

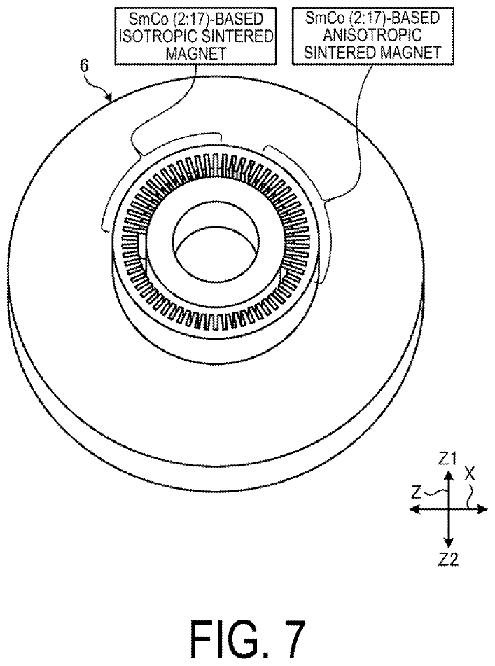

SmCo (2:17)-based anisotropic sintered magnets processed into a strip shape and SmCo (2:17)-based isotropic sintered magnets processed into a strip shape were prepared, and each was magnetized in the axial direction to prepare evaluation samples. FIG. 7 is a view for explaining an evaluation method in an example.

Then, 15 pre-magnetized SmCo (2:17)-based anisotropic sintered magnets (hereinafter referred to as anisotropic SmCo sintered magnets) and 15 pre-magnetized SmCo (2:17)-based isotropic sintered magnets (hereinafter referred to as isotropic SmCo sintered magnets) were embedded in the recess parts of the field magnet part 6 of the magnetizer 1 as illustrated in FIG. 7. Further, both the anisotropic sintered magnets and the isotropic sintered magnets were disposed such that different magnetic poles alternate in the circumferential direction. Next, a pin-shaped measuring instrument provided with a measuring probe at the tip was brought close to each sintered magnet and held at a position separated from the magnet by a predetermined distance, and the field magnet part 6 was rotated to measure the surface magnetic flux density as the generated magnetic field of each magnet.

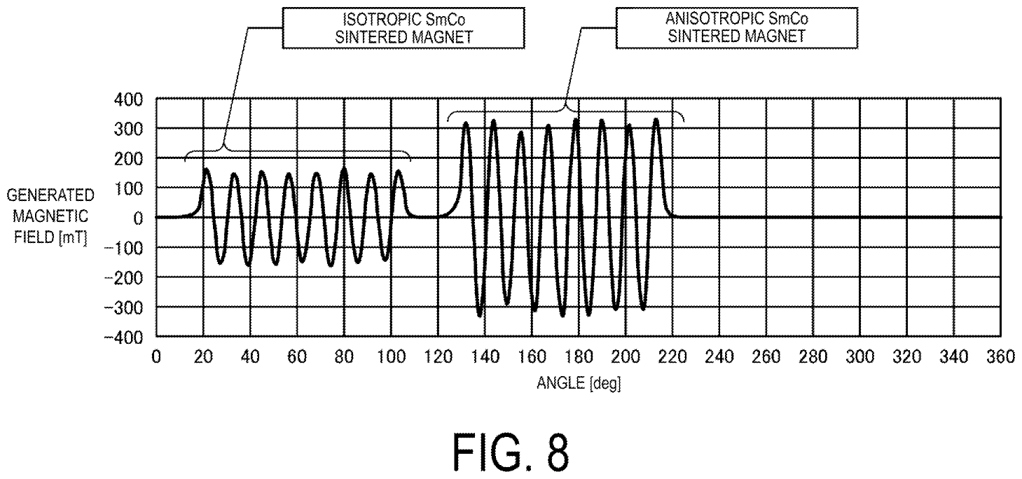

FIG. 8 is a view showing measurement results of the example. FIG. 8 shows the results obtained by measuring the surface magnetic flux density (mT) as the magnetic field generated by the magnets. In FIG. 8, the vertical axis represents surface magnetic flux density (mT), and the horizontal axis represents the angle by which the field magnet part 6 is rotated, that is, the position of each sintered magnet. It can be seen that, with respect to the magnetic field generated from magnets, the anisotropic SmCo sintered magnets have larger values than the isotropic SmCo sintered magnets as shown in FIG. 8.

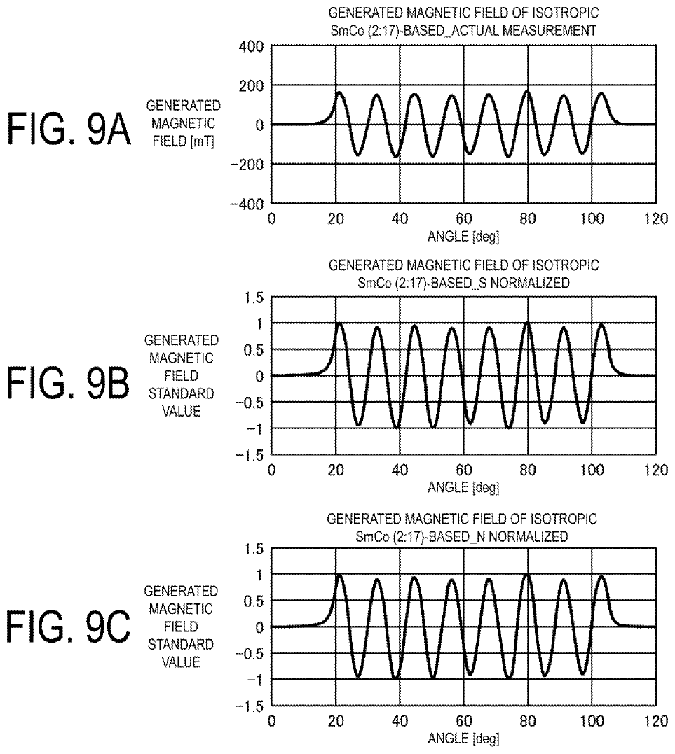

FIGS. 9A to 9C are views for explaining the generated magnetic fields of the isotropic SmCo sintered magnets illustrated in FIG. 8. FIG. 9A is an enlarged view of data of the generated magnetic field of the isotropic SmCo sintered magnets among the data shown in FIG. 8. FIG. 9B is a view showing the generated magnetic field of the isotropic SmCo sintered magnets shown in FIG. 8 normalized with the maximum generated magnetic field of the generated magnetic field at the S-pole side as 1 except for the generated magnetic fields from the magnets at both ends. FIG. 9C is a view showing the generated magnetic field of the isotropic SmCo sintered magnets shown in FIG. 8 normalized with the maximum generated magnetic field of the generated magnetic field at the N-pole side as 1 except for the generated magnetic fields from the magnets at both ends. That is, FIG. 9A shows the measured values of the isotropic SmCo sintered magnets, FIG. 9B shows the normalized values obtained by normalizing the peak values of the isotropic SmCo sintered magnets with the maximum value on the S-pole side, and FIG. 9C shows the normalized values obtained by normalizing the peak values of the isotropic SmCo sintered magnets with the maximum value at the N-pole side. Table 1 summarizing the numerical values of FIGS. 9A to 9C is shown below. Further, for N (measured values) and S (measured values) in Table 1, the peak value of the measured values at the N-pole side and the peak value of the measured values at the S-pole side are represented as absolute values. Furthermore, Nmax normalization in Table 1 indicates a normalized value of the peak value (absolute value) of the measured values on each N-pole side when the maximum peak value (maximum absolute value) of the measured values at the N-pole side is set to 1, and Smax normalization in Table 1 indicates a normalized value of the peak value (absolute value) of the measured values at each S-pole side when the maximum peak value (maximum absolute value) of the measured values on the S-pole side is set to 1.

TABLE 1

| | Maximum | Minimum | | | | | | | | |
|---|---|---|---|---|---|---|---|---|---|---|
| | value | value | Each peak value (absolute value) | | | | | | | |
| N (measured | 163 | 146 | 159.8 | 146 | 152 | 146 | 148.3 | 163 | 146.8 | 155.5 |
| value) | | | | | | | | | | |
| S (measured | 161.5 | 145.3 | 152.8 | 160.8 | 158.9 | 148.2 | 161.5 | 150.4 | 145.3 | |
| value) | | | | | | | | | | |
| Nmax | 1 | 0.8957 | 0.9804 | 0.8957 | 0.9325 | 0.8957 | 0.9098 | 1.0000 | 0.9006 | 0.9540 |
| normalization | | | | | | | | | | |
| Smax | 1 | 0.9176 | 0.9461 | 0.9957 | 0.9839 | 0.9176 | 1.0000 | 0.9313 | 0.8997 | |
| normalization | | | | | | | | | | |

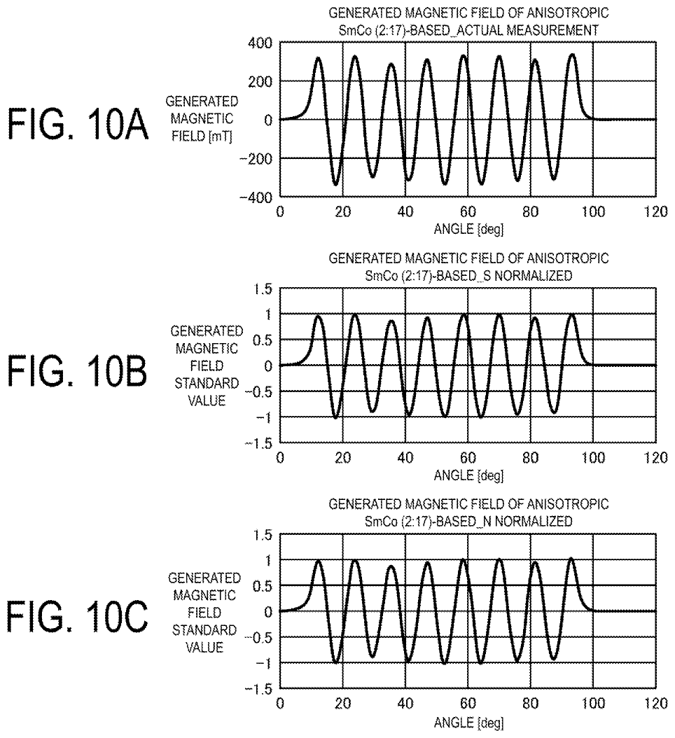

FIGS. 10A to 10C are views for explaining the generated magnetic fields of the anisotropic SmCo sintered magnets illustrated in FIG. 8. FIG. 10A is an enlarged view of data of the generated magnetic field of the anisotropic SmCo sintered magnets among the data shown in FIG. 8. FIG. 10B is a view showing the generated magnetic field of the anisotropic SmCo sintered magnets shown in FIG. 8 normalized with the maximum generated magnetic field of the generated magnetic field at the S-pole side as 1 except for the generated magnetic fields from the magnets at both ends. FIG. 10C is a view showing the generated magnetic field of the anisotropic SmCo sintered magnets shown in FIG. 8 normalized with the maximum generated magnetic field of the generated magnetic field at the N-pole side as 1 except for the generated magnetic fields from the magnets at both ends. That is, FIG. 10A shows the measured values of the anisotropic SmCo sintered magnets, FIG. 10B shows the normalized values obtained by normalizing the peak values of the anisotropic SmCo sintered magnets with the maximum value at the S-pole side, and FIG. 10C shows the normalized values obtained by normalizing the peak values of the anisotropic SmCo sintered magnets with the maximum value at the N-pole side. The numerical values of FIGS. 10A to 10C are summarized in Table 2 below. Because N (measured value), S (measured value), and Nmax normalization in Table 2 are the same as those in Table 1, description thereof will be omitted.

TABLE 2

| | Maximum | Minimum | | | | | | | | |
|---|---|---|---|---|---|---|---|---|---|---|
| | value | value | Each peak value (absolute value) | | | | | | | |
| N (measured | 329 | 289 | 319 | 328 | 289 | 311 | 329 | 327 | 310 | 335 |
| value) | | | | | | | | | | |
| S (measured | 334 | 295 | 334 | 295 | 314 | 334 | 332 | 315 | 309 | |
| value) | | | | | | | | | | |
| Nmax | 1.0000 | 0.8784 | 0.9696 | 0.9970 | 0.8784 | 0.9453 | 1.0000 | 0.9939 | 0.9422 | 1.0182 |
| normalization | | | | | | | | | | |
| Smax | 1.0000 | 0.8832 | 1.0000 | 0.8832 | 0.9401 | 1.0000 | 0.9940 | 0.9431 | 0.9251 | |
| normalization | | | | | | | | | | |

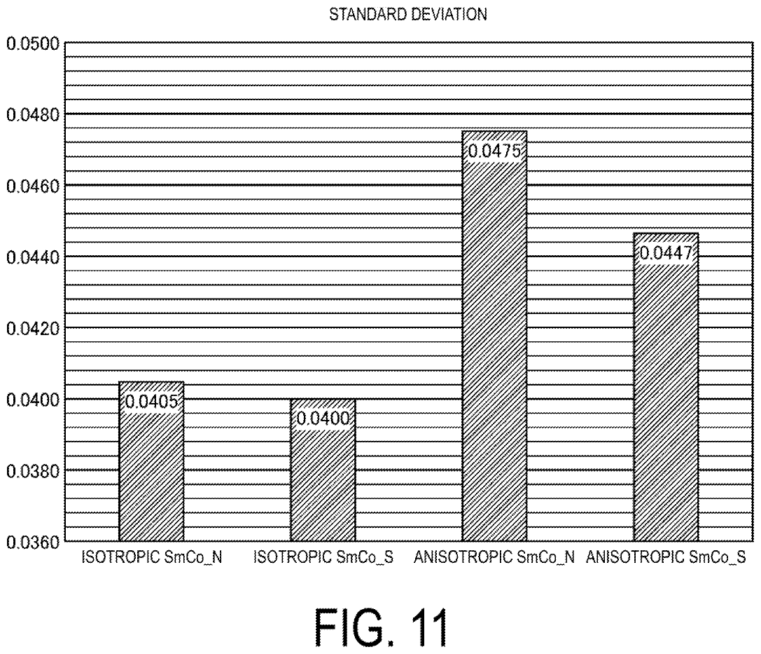

FIG. 11 is a graph showing the uniformity of the generated magnetic fields of evaluated samples in terms of standard deviation. In FIG. 11, isotropic SmCo_N is the standard deviation of the normalized value of Nmax normalization in Table 1, isotropic SmCo_S is the standard deviation of the normalized value of Smax normalization in Table 1, anisotropic SmCo_N is the standard deviation of the normalized value of Nmax normalization in Table 2, and anisotropic SmCo_S is the standard deviation of the normalized value of Smax normalization in Table 2. Further, when the standard deviations shown in FIG. 11 are calculated, the peak values of the magnets at both ends are removed because the magnets at the ends without magnets at both ends tend to have larger generated magnetic fields due to the magnetic path.

As shown in FIG. 11, the standard deviation of the isotropic SmCo sintered magnet is “0.0405” for the N pole and “0.0400” for the S pole. On the other hand, the standard deviation of the anisotropic SmCo sintered magnet is “0.0475” for the N pole and “0.0447” for the S pole. That is, it can be seen from FIG. 11 that the isotropic SmCo sintered magnet has a smaller standard deviation than the anisotropic SmCo sintered magnet, and the variation of the magnetic field generated from the isotropic SmCo sintered magnet is smaller than the variation of the magnetic field generated from the anisotropic SmCo sintered magnet. In addition, it can be seen from FIG. 11 that, when the variation of the standard deviation at the N-pole side is compared with the variation of the standard deviation at the S-pole side for the isotropic SmCo sintered magnet, the values of the standard deviations of both are substantially the same, and thus the variation between the two poles is also smaller than in the case of the anisotropic SmCo sintered magnet.

On the other hand, it can be seen that, in the anisotropic SmCo sintered magnet, the standard deviation (0.0475) at the N-pole side is larger than the standard deviation (0.0447) at the S-pole side, and thus the variation between the poles is large.

From the above evaluation results, the generated magnetic field of the isotropic SmCo sintered magnet has a smaller variation than the variation of the generated magnetic field of the anisotropic SmCo sintered magnet, and the generated magnetic field of the isotropic SmCo sintered magnet hardly varies between the poles. Therefore, by using the isotropic SmCo sintered magnet as the permanent magnet for magnetization of the magnetizer 1, the uniformity of the magnetization characteristics of the magnetic pattern of magnetization at the surface of the to-be-magnetized object can be improved.

Furthermore, the following points can be considered as advantages of using the isotropic SmCo sintered magnet as a permanent magnet for magnetization. First, since the isotropic magnet is non-oriented, it is not related to the disturbance of orientation that may occur in the anisotropic magnet, and if only the direction of magnetization in the manufacturing process of the isotropic magnet used for magnetization is accurately controlled, highly accurate magnetization is possible. That is, when a to-be-magnetized object is used in an actuator motor, strong magnetization characteristics are required for the purpose of increasing torque and design flexibility, and therefore it is important to generate a large magnetic field using an anisotropic SmCo sintered magnet and stably obtain strong magnetization characteristics at a saturation level. However, when a to-be-magnetized object is used in a sensing device (magnetic encoder), precise sensing is important, strong magnetization characteristics at a saturation level are not essential conditions, and only the magnetization direction of the permanent magnet for magnetization needs to be accurately controlled.

In addition, if the permanent magnet for magnetization is isotropic, the direction of magnetization is arbitrary, and thus fine adjustment becomes possible, which is advantageous for industrial use. That is, since the to-be-magnetized object is magnetized following the orientation direction of the permanent magnet for magnetization, if the orientation direction is shifted, it is difficult to correct the direction of the magnetic field generated from the magnetization. However, in the isotropic magnet, if the magnetization direction is strictly controlled, it is possible to increase the accuracy of the orientation direction and finely adjust the orientation direction by intentionally shifting the magnetization direction. In addition, when the to-be-magnetized object is used in a magnetic encoder, the magnetization intensity at the saturation level is not necessary, and it is only necessary to obtain a constant magnetization intensity at which the to-be-magnetized object can operate as a magnetic encoder, and thus the magnitude of the magnetization intensity can be finely adjusted, and high accuracy can be achieved. In addition, since fine adjustment is possible, yield can be improved, which is advantageous for industrial use. In addition, since an isotropic magnet is easier to manufacture than an anisotropic magnet, the costs for magnetizing a to-be-magnetized object can be reduced.

### Modification Example of Magnetizer

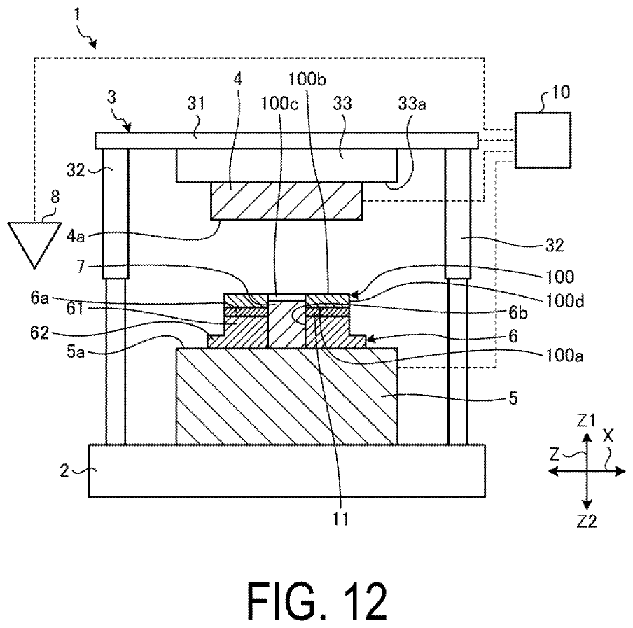

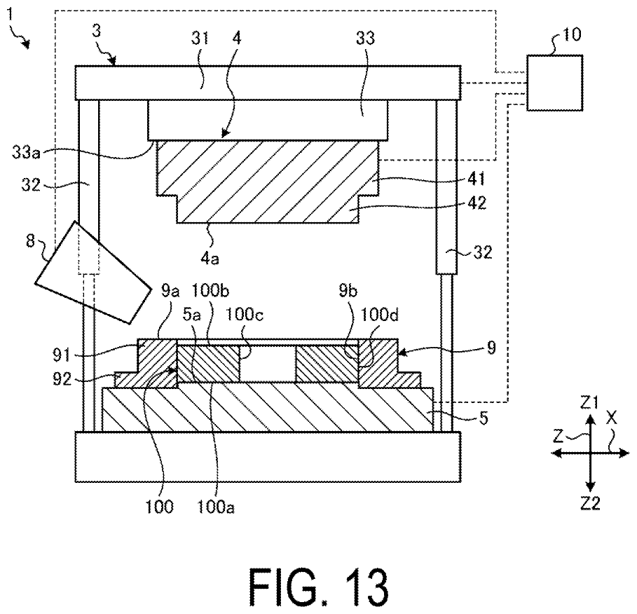

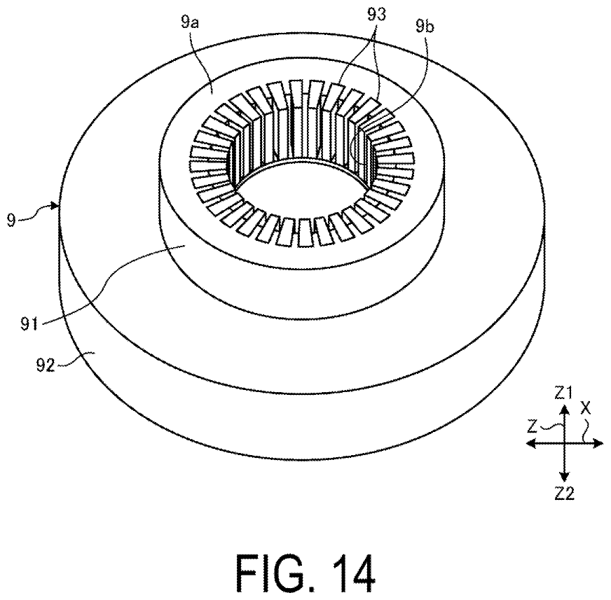

Further, the magnetizer used in the permanent magnet manufacturing method is not limited to the magnetizer 1 illustrated in FIG. 1. Hereinafter, modification examples of the magnetizer will be described with reference to FIGS. 12 to 14. FIG. 12 is a view illustrating a schematic configuration example of a magnetizer according to a first modification example. FIG. 13 is a view illustrating a schematic configuration example of the magnetizer according to the first modification example, and FIG. 14 is a perspective view illustrating a field magnet part of the magnetizer illustrated in FIG. 13.

### First Modification Example of Magnetizer

First, a magnetizer 1 according to a first modification example shown in FIG. 12 will be described. Since the basic configuration of the magnetizer 1 illustrated in FIG. 12 is the same as the basic configuration of the magnetizer 1 illustrated in FIG. 1, configurations denoted by the same reference numerals will be omitted or simplified for description. The X direction illustrated in FIG. 12 is a radial direction of a to-be-magnetized object, and the Z direction is an axial direction of the to-be-magnetized object and is a vertical direction. The Z1 direction illustrated in FIG. 12 is the upward direction, and the Z2 direction is the downward direction.

The magnetizer 1 according to the first modification example illustrated in FIG. 12 is different from the magnetizer 1 according to the embodiment illustrated in FIG. 1 in that a spacer 11 made of a non-magnetic material is placed the field magnet part 6, and the spacer 11 is interposed between the field magnet part 6 and the to-be-magnetized object 100. In addition, another difference is that the to-be-magnetized object 100 is magnetized by the field magnet part 6 via the spacer 11.

The spacer 11 is a member that is placed at the placement surface 6a of the field magnet part 6 and interposed between the field magnet part 6 and the to-be-magnetized object 100. The spacer 11 is formed of, for example, a non-magnetic metal material in a ring shape. Non-magnetic stainless steel, a titanium alloy, brass, and the like can be given as examples of the material that can be made thin with a non-magnetic metal material, and the spacer 11 is preferably made of these materials. Further, the material is not limited to a non-magnetic metal material as long as it has heat resistance at 350° C. or higher because it is heated. For example, non-magnetic ceramics may be used.

The outer diameter of the spacer 11 is the same as the placement surface 6a of the field magnet part 6. In addition, the spacer 11 is preferably formed to be 0.7 mm or less thick in the axial direction, and more preferably 0.3 mm or less thick in the axial direction. When the spacer has a thickness greater than 0.7 mm, magnetization of the to-be-magnetized object may be difficult. By interposing the spacer 11 made of non-magnetic metal material between the field magnet part 6 and the to-be-magnetized object 100, the attraction force between the magnetized object 100′ and the field magnet part 6 can be reduced after the to-be-magnetized object 100 is magnetized. As a result, the magnetized object 100′ can be easily removed from the field magnet part 6. Furthermore, when the magnetized object 100′ is removed from the field magnet part 6, it is possible to prevent a part of the magnetized object 100′ from being chipped and to prevent the edge of the magnetized object 100′ from damaging the isotropic SmCo sintered magnets which are the permanent magnets for magnetization exposed at the placement surface 6a of the field magnet part 6.

Further, the operation of the magnetizer 1 according to the first modification example in the magnetization method for the to-be-magnetized object 100 is the same except that the to-be-magnetized object 100 is placed at the field magnet part 6 via the spacer 11, and thus description thereof will be omitted.

### Second Modification Example of Magnetizer

Next, a magnetizer 1 according to a second modification example illustrated in FIG. 13 will be described. Although the case of the permanent magnet manufacturing method according to the present embodiment using an isotropic SmCo sintered magnet as a permanent magnet for magnetization being applied to the magnetizer 1 that magnetizes the to-be-magnetized object 100 in the axial direction has been described in FIGS. 1 and 2, the method is not limited to the aforementioned. The permanent magnet manufacturing method according to the present embodiment is also applicable to a magnetizer that magnetizes the to-be-magnetized object 100 in the radial direction. Further, since the basic configuration of the magnetizer 1 illustrated in FIG. 13 is the same as the basic configuration of the magnetizer 1 illustrated in FIG. 1, the configurations denoted by the same reference numerals will be omitted or simplified for description.

A heating unit 4 includes a main body part 41 and a protruding part 42. The main body part 41 is formed in a disc shape, and among both surfaces in the vertical direction, the upper side surface is fixed to a heating unit mounting base 33 of a movement unit 3, and the protruding part 42 is formed to protrude downward from the lower side surface. The lower side surface of the protruding part 42 in the vertical direction is a heating surface 4a. The heating surface 4a has a diameter smaller than the diameter of an insertion hole 9b of a field magnet part 9.

The upper side surface of a preheating unit 5 is a placement/heating surface 5a, and is formed in two stages. A to-be-magnetized object 100 is placed and heated at the first stage at the upper side of the placement/heating surface 5a, and the field magnet part 9 is placed and heated at the second stage at the lower side thereof.

The field magnet part 9 illustrated in FIGS. 13 and 14 generates a magnetic field for the to-be-magnetized object 100. The field magnet part 9 according to the second modification example magnetizes the to-be-magnetized object 100 in the radial direction, and includes a main body part 91, a flange part 92, and permanent magnets 93 which are permanent magnets for magnetization. The main body part 91 is made of a non-magnetic metal material in a cylindrical shape, the lower side surface of both surfaces in the vertical direction is fixed to the second stage of the placement/heating surface 5a of the preheating unit 5, and an upper side surface 9a faces a ceiling plate 31 in the axial direction. An insertion hole 9b into which the to-be-magnetized object 100 is inserted is formed in the main body part 91. The flange part 92 is formed to protrude radially outward from the lower end part of the main body part 91. The flange part 92 fixes the field magnet part 9 to the preheating unit 5 by inserting a fixing tool, for example, a fastening screw, into a through hole, which is not illustrated, and the fixing tool is fixed to the preheating unit 5 with the field magnet part 9 placed at the second stage of the placement/heating surface 5a of the preheating unit 5.

The permanent magnets 93, which are permanent magnets for magnetization, are, for example, rectangular isotropic SmCo magnets, are embedded at the insertion hole 9b side of the main body part 91 in the radial direction, and generate a magnetic field for the to-be-magnetized object 100. When viewed in the vertical direction, a plurality of permanent magnets 93 are arranged at equal intervals in the circumferential direction of a concentric circle around the center of the main body part 91. Each of the permanent magnets 93 has two magnetic poles (an S pole and an N pole) at the radially inner and radially outer sides, and is embedded in the main body part 91 such that the different magnetic poles alternate in the circumferential direction. Here, the magnetic pole (for example, the S pole) at the radially inner side of a permanent magnet 93 is different from the magnetic pole (for example, the N pole) at the radially inner side of the permanent magnet 93 which is adjacent in the circumferential direction, and the magnetic pole (for example, the N pole) at the radially outer side of the permanent magnet 93 is different from the magnetic pole (for example, the S pole) at the radially outer side of the permanent magnet 93, which is adjacent in the circumferential direction. Further, although the permanent magnets 93 are embedded in the main body part 91 while being exposed at the insertion hole 9b, the permanent magnets 93 may be embedded inside the main body part 91 without being exposed at the insertion hole 9b.

Next, a method of magnetizing the to-be-magnetized object 100 by the magnetizer 1 according to the second modification example will be described. Further, the same parts as those of the magnetization method by the magnetizer 1 according to the embodiment will be omitted or simplified for description. First, a control unit 10 starts heating of the heating unit 4 and the preheating unit 5. Next, with the to-be-magnetized object 100 and the insertion hole 9b of the field magnet part 9 facing each other in the axial direction, an operator moves the to-be-magnetized object 100 downward, inserts the to-be-magnetized object 100 into the insertion hole 9b of the field magnet part 9, and places the to-be-magnetized object 100 at the first stage of the placement/heating surface 5a of the preheating unit 5. At this time, the operator positions the to-be-magnetized object 100 with respect to the magnetizer 1 by inserting the to-be-magnetized object 100 into the insertion hole 9b. Further, the outer circumferential surface 100d of the to-be-magnetized object 100 faces the field magnet part 9 in the radial direction, and the upper side surface 100b faces the heating surface 4a of the heating unit 4 in the axial direction.

Next, after the to-be-magnetized object 100 has been placed at the placement/heating surface 5a and a first predetermined time T1 has elapsed, the control unit 10 causes the movement unit 3 to move the heating unit 4 from the non-heating position to the heating position with respect to the to-be-magnetized object 100 to start heating of the preheated to-be-magnetized object 100, and after a second predetermined time T2 has elapsed from the start of heating of the to-be-magnetized object 100 at the heating position, the control unit 10 causes the movement unit 3 to move the heating unit 4 from the heating position to the non-heating position with respect to the to-be-magnetized object 100. The control unit 10 causes the cooling unit 8 to cool the to-be-magnetized object 100 at the non-heating position, and causes the cooling unit 8 to stop cooling at the non-heating position after a third predetermined time T3 has elapsed since the cooling unit 8 started cooling. Next, the operator takes out the magnetized object 100′.

As described above, the magnetizer 1 according to the second modification example magnetizes the to-be-magnetized object 100 by increasing the temperature of the to-be-magnetized object 100 from a temperature lower than the Curie point to a temperature equal to or higher than the Curie point and decreasing the temperature thereof from the temperature equal to or higher than the Curie point to a temperature lower than the Curie point while the magnetization magnetic field is applied by the field magnet part 9. As a result, the magnetizer 1 manufactures a magnetized object from the to-be-magnetized object 100. The magnetized object is magnetized at regions corresponding to the permanent magnets 93 of the field magnet part 9. The magnetized object of the modification example is a permanent magnet having a magnetization region corresponding to each permanent magnet 93, that is, one row of at least the outer circumferential surface 100d is magnetized to be multipolar. The magnetized object 100′ of the second modification example is a permanent magnet having a magnetization region corresponding to each permanent magnet 93, and a permanent magnet having one row of at least the outer circumferential surface 100d magnetized to be multipolar.

In addition, although the magnetizer 1 according to the second modification example is configured to manufacture a permanent magnet that is magnetized to be multipolar in one row at the outer circumferential surface 100d of the to-be-magnetized object 100, the magnetizer 1 is not limited to the aforementioned. The permanent magnets 93 provided at the field magnet part 9 may be coaxially arranged in a plurality of rows (for example, two rows) separated from each other in the axial direction. In this case, the outer circumferential surface 100d of the to-be-magnetized object 100 can be subjected to multipolar magnetization in a plurality of rows (for example, two rows) in the axial direction.

Further, although the heating unit 4 reaches the heating temperature before reaching the heating position in the above-described embodiment and modification examples, the heating unit 4 is not limited to the aforementioned, and the heating unit 4 may be heated to a standby temperature lower than the heating temperature at the non-heating position, and the temperature may be increased from the standby temperature to the heating temperature at the heating position while the heating surface 4a is in contact with the to-be-magnetized object 100.

Moreover, the disclosure is not limited to the embodiments described above. A configuration obtained by appropriately combining the above-mentioned constituent elements is also included in the disclosure. Further effects and modification examples can be easily derived by a person skilled in the art. Thus, a wide range of aspects of the disclosure are not limited to the embodiments described above and may be modified variously.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

1. A permanent magnet manufacturing method comprising:
disposing a field magnet part near a to-be-magnetized object, the field magnet part having a plurality of permanent magnets for magnetization arranged at predetermined intervals to apply a magnetization magnetic field to the to-be-magnetized object, and heating the to-be-magnetized object to a temperature equal to or higher than the Curie point of the to-be-magnetized object; and
cooling the to-be-magnetized object having reached the temperature equal to or higher than the Curie point to a temperature lower than the Curie point and continuously applying a magnetization magnetic field to the to-be-magnetized object by the field magnet part, wherein
the permanent magnets for magnetization are isotropic SmCo sintered magnets in a predetermined shape.

2. The permanent magnet manufacturing method according to claim 1, wherein the permanent magnets for magnetization are strip-shaped isotropic SmCo sintered magnets.

3. A magnetizer comprising:
a field magnet part having a plurality of permanent magnets for magnetization that generate a magnetization magnetic field for a disc-shaped to-be-magnetized object arranged at equal intervals in a circumferential direction;
a heating unit having a heating surface facing the to-be-magnetized object in an axial direction of the to-be-magnetized object and configured to heat the to-be-magnetized object to a temperature equal to or higher than the Curie point of a magnetic powder constituting the to-be-magnetized object;
a movement unit configured to move the to-be-magnetized object and the heating unit with respect to each other between a non-heating position and a heating position in the axial direction of the to-be-magnetized object; and
a control unit configured to control at least the heating unit and the movement unit, wherein
the permanent magnets for magnetization are isotropic SmCo sintered magnets in a predetermined shape,
the non-heating position is a position at which the heating surface is separated from the to-be-magnetized object in the axial direction and the to-be-magnetized object is not heated by the heating unit, and
the heating position is a position at which the heating surface is close to the to-be-magnetized object in the axial direction and the to-be-magnetized object is heated by the heating unit.
